(19) United States
(12) Patent Application Publication
(10) Pub. No.: US 2026/0278635 A1
(43) Pub. Date: Sep. 17, 2026

(54) TRADESHOW BACKDROP AUGMENTED REALITY SYSTEM

(71) Applicant: Trade Show Display Corp., Austin, TX (US)

(72) Inventor: Steve Rad, Austin, TX (US)

(21) Appl. No.: 19/077,226

(22) Filed: Mar. 12, 2025

(51) Int. Cl. G06Q 30/0207; G06V 20/20

(52) U.S. Cl. CPC G06Q 30/0236; G06Q 30/0209; G06V 20/20

(57) ABSTRACT

An augmented reality system and method of obtaining user contact information that includes displaying a display member that includes at least a first image target that includes first linked augmented reality content and prompting a user to utilize a mobile device that includes software running thereon that is associated with the augmented reality system. The software is in communication with a target database. In use, the user orients the mobile device such that the camera lens is directed toward the display member, the first image target is recognized by the software and the first linked augmented reality content is displayed on the mobile device. The user is then prompted to submit their user contact information, which may be then stored in a user database. The user is then provided with a prize after the user has submitted the user contact information.

### FIELD OF THE INVENTION

The present invention relates generally to an augmented and reality system for use with tradeshow booth backdrops or other large printed materials.

### BACKGROUND OF THE INVENTION

Companies or entities that have a booth at tradeshows are always looking for ways to attract attendees and traffic to their booth. The present invention is directed to this issue.

The background description disclosed anywhere in this patent application includes information that may be useful in understanding the present invention. It is not an admission that any of the information provided herein is prior art or relevant to the presently claimed invention, or that any publication specifically or implicitly referenced is prior art.

### SUMMARY OF THE PREFERRED EMBODIMENTS

In accordance with a first aspect of the present invention there is provided a method of and system for obtaining user contact information using an augmented reality system. The method may include displaying a display member that includes at least a first image target that includes first linked augmented reality content, and prompting a user to utilize a mobile device that includes software running thereon that is associated with the augmented reality system. The software is in communication with a target database. The mobile device includes a camera that has a camera lens. The user orients the mobile device such that the camera lens is directed toward the display member, the first image target is recognized by the software and the first linked augmented reality content is displayed on the mobile device. The user views the first linked augmented reality content on a screen of the mobile device. The method may include prompting the user to submit the user contact information. After being submitted, the user contact information is stored in a user database and the method includes providing the user with a prize after the user has submitted the user contact information. The method may be performed at a tradeshow, and the display member may be displayed in a booth that includes an exhibitor. The first linked augmented reality content may be a game that includes a prize indicator that is associated with the prize. In the method, the user plays the game and is informed of the prize indicator (via video or display content—on the screen, or via audio). The prize may be a discount code. The mobile device may be provided by the exhibitor or by the user.

In accordance with another aspect of the present invention, there is provided an augmented reality system that includes at least a first display member that includes a first image target, and software that is configured to run on a mobile device that includes a camera that has a camera lens. The software is in communication with a target database that includes information related to the first image target. The software includes first augmented reality content that is associated with the first image target. The first augmented reality content is a first game configured to provide a first user with a first prize indicator. After the first user submits first user contact information to a user database a first prize is delivered to the first user via the first user contact information.

In a preferred embodiment, the first display member is associated with a first booth and a first exhibitor. The augmented reality system may include at least a second booth and a second exhibitor and a second display member is associated with the second booth and the second exhibitor. The target database may include information related to the second image target and the software may include second augmented reality content that is associated with the second image target. The second augmented reality content is a second game configured to provide the first user or a second user with a second prize indicator. The second game may be the same as the first game. In other words, the same game may played via the display member at each of the different or first and second booths. Or, the first and second games may be different such that a different game (and associated content) can be played at different booths. The second user submits second user contact information to the user database after playing the second game and a second prize is delivered to the second user via the second user contact information. It will be appreciated that the same user may play a game at different booths.

In a preferred embodiment, the augmented reality system includes an exhibitor database that includes first exhibitor information associated with the first exhibitor and second exhibitor information associated with the second exhibitor. The first user contact information may be associated with the first exhibitor and the second user contact information may be associated with the second exhibitor.

In a preferred embodiment, the present invention includes a system that includes a booth backdrop or other display member and a software application (“app”) that may be downloaded by attendees, consumers or the like. In use, an attendee or consumer that has the app on their phone or other mobile device can use the app to participate in an augmented reality (“AR”) activation at one or more vendor's tradeshow booth(s). The AR activation may be, for example, a prize wheel or other engaging experience. The event may be a tradeshow, conference, farmer's market, mall or other location or event that includes vendors/exhibitors and attendees where the vendors are desirous of driving traffic to their booth or store and/or obtaining attendee or consumer information, data or leads. These types of events are referred to herein generally as a tradeshow event. However, it should be understood that the term tradeshow is not limiting.

Generally, target-based augmented reality devices (“AR device”) allow users to view information linked to image targets identified by the devices in real time. In the present invention, the AR device is a mobile device, which may be a smart phone (e.g., iPhone, Google phone, or other phones running Android, Windows Mobile, or other operating systems), a tablet computer (e.g., iPad, Galaxy), personal digital assistant (PDA), a notebook computer, or various other types of wireless or wired computing devices, that includes associated software running thereon (typically in the form of an app). The user can view the content on the screen of the AR device and be provided a simultaneous real-world view.

The AR activation may appear in the app on the user's mobile device, when an AR image target on the backdrop or other display member is recognized. As part of the process, the user may enter contact information, such as an email address, phone number, name, street address, etc. The entry of the contact information may be necessary for the user to claim a prize or receive some piece of information (which may be considered a prize), etc. This allows the vendor or exhibitor to capture user or attendee information for marketing or other purposes. Therefore, there is an exchange between the user and the exhibitor where the user receives something, such as a prize, information, a visual experience (in the app), etc. and the exhibitor receives information from the user, which may be referred to as a conversion. The conversion may be user contact information, subscribing to the exhibitor's Youtube channel, Facebook page or other social media, etc. The display member includes one or more image targets that may be graphics, text, etc. The exhibitor may purchase the display member and the image target(s) thereon may be added to or included in the image target database associated with the app. In other words, an entity may control both the image target database and the distribution of the display members or backdrops that include the image targets associated with the database to vendors or exhibitors. For example, a vendor may purchase a backdrop or display member for their booth at an upcoming tradeshow from an entity or “service provider” that makes and sells tradeshow backdrops or display members. An image target is associated with or disposed on or in the backdrop or display member and that image target is associated with the image target database.

Users or consumers at the tradeshow can be informed to download the associated app (e.g., titled “backdrop AR” or backdrop. com). At the tradeshow, when a user with the backrop AR app directs their phone at the particular display member obtained or purchased by the exhibitor and the image target is recognized, the associated augmented reality content is displayed on the user's screen. In another scenario, the exhibitor at the booth may have a dedicated mobile device (e.g., a phone or tablet) that can be handed to or temporarily given to a user or attendee so that they can use the app to participate in the augmented reality activation. Then, once the user has, for example, obtained their discount and entered their user information, the mobile device can be given back to the exhibitor. Either way, the user gets a prize, discount or some benefit and the exhibitor obtains a new lead.

In an example where the associated augmented reality content is a discount prize wheel, the user may be prompted to hit or touch “spin” on the screen. Once the prize wheel is “spun” within the app the user may obtain a discount amount (e. g,. 20%) allowing them to purchase a product from the exhibitor for a 20% discount. In order to obtain a coupon or code or the like associated with the discount, the user must enter their contact information (e.g., email address). Once the user email address is entered, the discount code or information is emailed to the user, and the exhibitor is provided with the user's email address (a lead is converted). The service provider may control the database that includes all of the marketing leads or user information that is obtained and the user information may be associated with specific exhibitors or a database related thereto. The exhibitor may control the database that collects the user information or leads.

Exemplary steps include an exhibitor signing up for the backdrop service at a website, such as backdrop. com and creating a dashboard. The dashboard may include connection to shopify (e.g., via an API or the like) or not. The exhibitor orders a tradeshow booth backdrop or display member and the backdrop is shipped to the exhibitor. The backdrop is used at a tradeshow. At the tradeshow, a consumer plays the game (using their own phone or via a tablet or the like at the booth) and enters their contact information. After entry of the contact information, an email is sent via the dashboard or the like from the exhibitor to the consumer. The system may be configured such that the email comes from the exhibitor (e.g., from exhibitorA.com) or from backdrop. com (from the app owner). The dashboard (and associated database(s), etc.) may also include the ability to track conversions (e.g., whether a lead purchased something) and even whether an email was opened and/or read.

The present invention may also be used by the entity that owns or runs a specific tradeshow or the “service provider” where it is announced that a predetermined number of booths at a tradeshow include display members that include AR activations. For example, if there are a hundred booths at a tradeshow, it may be announced that twelve booths that are “backdrop alive” and this provides motivation for attendees to direct their mobile device with the app thereon at each of the hundred booths to determine which are “backdrop alive.” Think of a game like Pokemon Go. This may act like a scavenger hunt to drive the attendees to the participating booths. The app may require the attendee or user to provide their contact information to participate in the “scavenger hunt” and the conversion may be the app provider's and then the customer information may be provided to all of the exhibitor's that participated in the “scavenger hunt” and that include AR activated backdrops in their booth.

Augmented reality target detection is taught in U.S. Pat. No. 9,401,048 and augmented reality experiences is taught in US Patent Publication No. 2019/0213417, the entireties of which are incorporated herein by reference.

### BRIEF DESCRIPTION OF THE DRAWINGS

FIG. 1 shows a user directing a mobile device at a tradeshow booth having a display member that is part of an augmented reality system in accordance with a preferred embodiment of the present invention;

FIG. 2 is a closeup of the mobile device with the display member in the background;

FIG. 3 is an example of first linked augmented reality content showing a prize wheel being displayed on the screen of a mobile device;

FIG. 4 is an example of a user contact information box being displayed on the screen of a mobile device;

FIG. 5 is a block diagram showing the augmented reality system in communication through a network with a target database, user database and exhibitor database; and

FIG. 6 is a block diagram of a computer system suitable for implementing one or more components discussed herein.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments.

Reference in this specification to “one embodiment” or “an embodiment” means that a particular feature, structure, or characteristic described in connection with the embodiment is included in at least one embodiment of the-disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

The detailed description provides explanations by way of exemplary embodiments. It is to be understood that other embodiments may be used having mechanical and electrical changes that incorporate the scope of the present invention without departing from the spirit of the invention.

While certain embodiments of the present invention are described in detail above, the scope of the invention is not to be considered limited by such disclosure, and modifications are possible without departing from the spirit of the invention as evidenced by the following claims.

Referring now to the drawings, wherein the showings are for purposes of illustrating the present invention and not for purposes of limiting the same, the drawings show components of an augmented reality system and method for collecting or obtaining user contact information or marketing leads at a tradeshow, conference, farmer's market, pop up or other event. As used herein, the term tradeshow may mean any event where an exhibitor (e.g., company, business, individual, store) has a location, such as a booth, kiosk or other area where they may encounter attendees, users or the like. Use of the term tradeshow is not limiting. For example, the exhibitor may utilize a display member with linked augmented reality content as discussed herein at their store in a mall or the like.

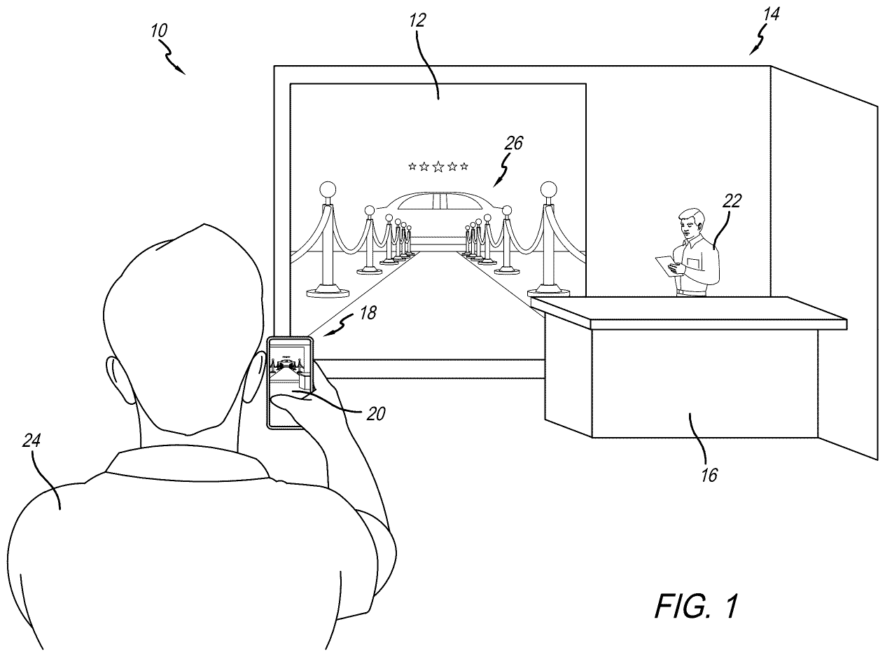

Reference is made to FIGS. 1-6. As shown in FIG. 1, in a preferred embodiment, the augmented reality system 10 generally may include a display member 12 and a mobile device 18. The display member 12 may be included in a tradeshow booth 14, which may include a table 16. The booth 14 may be owned, leased or otherwise used by an exhibitor 22. In FIG. 1, the exhibitor 22 is an individual working at the booth. However, this is not limiting and the term exhibitor may refer generally to the booth or location owner, as discussed further above.

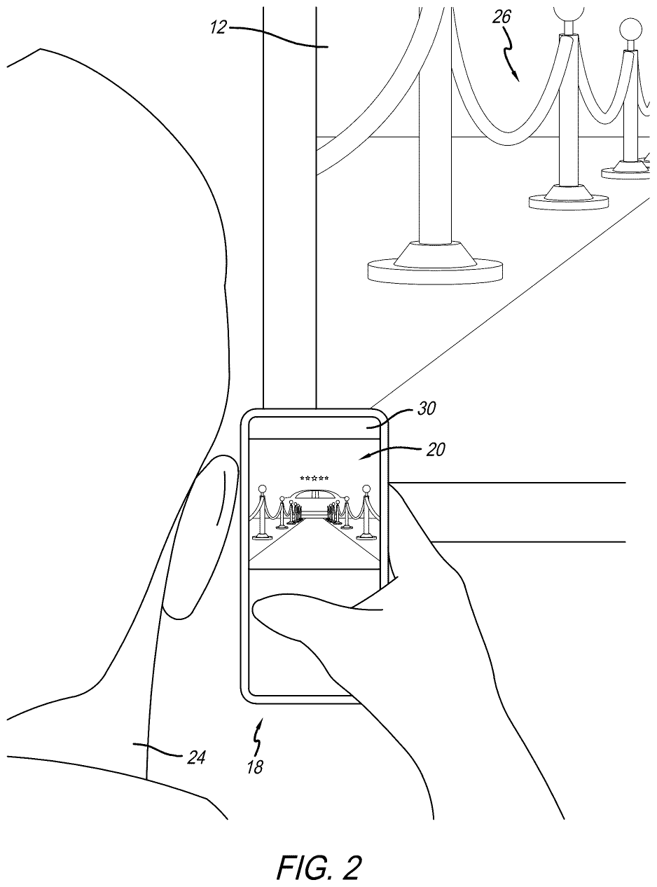

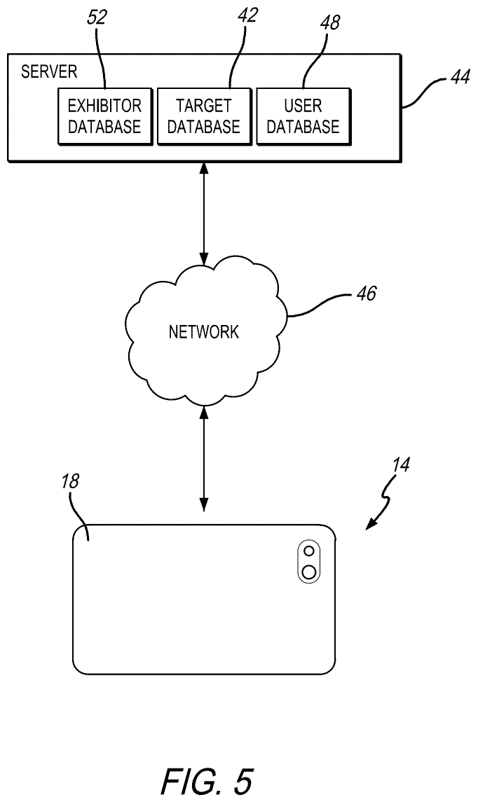

The display member 12 may be, for example, a book, poster, backdrop, brochure, etc. The display member 12 may also be an electronic file that is viewable on a computer, TV or display screen. As discussed herein, in a preferred embodiment, the present invention includes software that can be downloaded to the mobile device 18 in the form of an app. FIG. 1 shows a mobile device 18 with an exemplary app 20 thereon that is associated with the software program being held by a user 24. As shown in FIGS. 1 and 2, in a preferred embodiment, the display member 12 includes at least a first image target 26. In the exemplary embodiment in the figures, the first image target is a red carpet scene with a red carpet, ropes and a car. In use, the image target 26 is recognized by the software and, as a result of being recognized, certain actions may take place, including displaying linked augmented reality content 28 on the screen 30 of the mobile device 18. As shown in FIG. 5, the system includes a target database 42. In a preferred embodiment, the target database 42 is part of the software program downloaded to the mobile device 18. However, in another embodiment, the target database 42 can be stored on a remote server 44 or the like that is accessible via a network 46, such as the internet.

Each image target 26 includes augmented reality content or virtual reality content linked thereto or associated therewith. As will be appreciated by those of ordinary skill in the art, the image targets can be any of the printed material (or material on a digital display or screen) that is recognized by the software. The image targets can be a particular picture, drawing, word or set of words, QR code or other recognizable display or item that causes the software to access the associated augmented reality content. The display member 12 may include multiple image targets. The booth 14 may include multiple display members 12 or multiple image targets.

The mobile device 18 may be associated with the booth 14 and exhibitor 22 or the mobile device 18 may be associated with the user 24. In other words, the mobile device 18 may be one that is at the booth and is handed to each user by the exhibitor or the users may be prompted or informed to download the app so that they can use their personal mobile device.

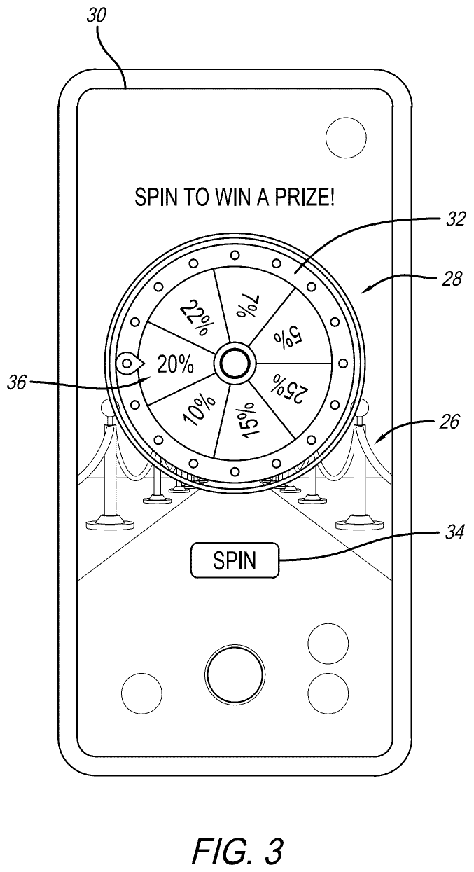

In use, as shown in FIGS. 1 and 2, the user orients the mobile device 18 such that the camera lens is directed toward the display member 12. When the first image target 26 is recognized by the software, the first linked augmented reality content 28 is displayed on the mobile device 18. As shown in FIG. 3, the first linked reality content 28 may include a game. In the example shown in the drawings, the first linked augmented reality content or game is a prize wheel 32 that includes a set of discounts thereon (e.g., 5%, 7%, 10%, 15%, 20% and 25%). The first linked augmented reality content 28 also includes a button 34 that when “pressed” or actuated causes the prize wheel 32 to spin. The game is for the person to press the button to spin the wheel and obtain a discount or prize. As shown in FIG. 3, the indicator on the wheel is pointing to 20%, indicating that the user may receive a 20% discount. This is referred to herein as a prize indicator 36. The prize indicator 36 is any information provided to the user after playing the game informing them that they have won or are entitled to a prize. In other words, the user is informed of what their prize, free item or discount may be (which may all be referred to herein as a prize). However, the user has to go through further steps in order to obtain the actual prize or discount. The prize may also be a digital object or the like. For example, the tradeshow may include a scavenger hunt where if the user collects a predetermined number of digital items they receive a prize.

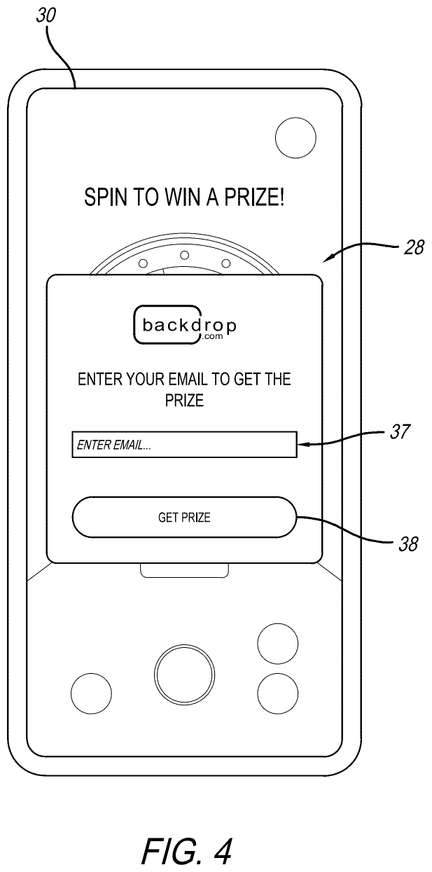

As shown in FIG. 4, after the user has played the game, they are prompted to enter their user contact information to obtain the prize. The app may include a user contact information box 37 or boxes where the user contact information may be entered. FIG. 4 also shows a button 38 that submits the user contact information when actuated by the user. The user contact information may be stored in a user database 48 (see FIG. 5). Once the user has entered and submitted the user contact information, the system may then be prompted to send to the user the prize using the user contact information. The user contact information may be one or more of an email address, phone number, physical address or other information associated with a social media platform or the like. The user contact information may also be signing up for or joining a social media or other platform associated with the exhibitor. For example, subscribing to or joining an exhibitor's Youtube, Facebook, Instagram, X or the like may be considered submitting user contact information.

In an embodiment of the invention, an exhibitor or entity that signs on to use the app to collect user (consumer) information may be prompted to add information to a dashboard. For example, the exhibitor may create or have a shopify, hubspot or other selling type account and may have a related dashboard and database, etc. By connecting or associating the exhibitor shopify account with the backdrop. com account and/or app, an email may be sent by the exhibitor shopify account when a user plays the game or otherwise enters contact information through the app. In this scenario, the user database or user contact information storage may be part of the shopify or similar service's account, server and/or database, thus bypassing storage of user information in or on the backdrop. com (or other owner) servers or database.

The type of prize is not a limitation on the present invention. The prize may be a discount, a free item, a coupon or the like and may be embodied in the form of a discount code or the like that is emailed, messaged or otherwise delivered to the user. For example, in a booth where the exhibitor sells televisions, by playing the game and submitted their user contact information, the user may be emailed a discount code that can be used at the exhibitor's website for obtaining twenty percent off of the purchase of a television. The discount code may provide any discount from 1%-100%. In other words, the discount code may provide a free item.

The augmented reality content may also include audio. The audio may include instructions for how to play the game, to enter user contact information and/or what the prize indicator or prize is. It will be appreciated that augmented reality generally means that on the screen of the mobile device, the user may see the augmented reality content superimposed over the scene displayed by the camera. For example, as shown FIG. 2, the prize wheel related augmented reality content is superimposed over the red carpet scene from the display member 12. The augmented reality content may also be virtual reality content, which means that the entire screen may display content associated with the software and not show the “real world” item (e.g., display member) from the camera screen. This is also considered augmented reality content in the scope of the present invention.

As shown in FIG. 5, in a preferred embodiment, the system may include an exhibitor database 52. It will be appreciated that the target database, user database and exhibitor database displayed in FIG. 5 may exist on the same or separate/remote servers. Any networked or communicated configuration of databases, servers and/or storage locations or mediums is within the scope of the present invention and no configuration should be considered limiting. Embodiments of the system may include different apps or different software programs for each exhibitor or a single app or software program that is utilized by, distributed by, associated with or controlled by a controlling entity, company, association or the like. For example, FIG. 4 includes “backdrop. com” thereon. The entity that controls backdrop. com may distribute or own the app. Multiple exhibitors at the same tradeshow or separate tradeshows may sign up or register to use the app. These exhibitors are included in the exhibitor database 52. In use, when a user's user contact information is obtained at a booth or via a known image target, that user's contact information may be associated with the specific exhibitor. Therefore, the exhibitor database and user database may be part of the same database or may be linked to or associated with one another. This system may provide the controlling entity to obtain contact information from all of the users and individual exhibitors to obtain the contact information of the individual users that they are able to collect information from. The entity controlling or putting on the tradeshow or event (which may be referred to herein as a “service provider”) may also be part of the system and they may be able to obtain some or all of the user contact information obtained during a predetermined amount of time or at a particular location (e.g., at the event location).

It will be appreciated by those of skill in the art that any type of computer mobile device, tablet or the like can be used with the present invention. The mobile device 18 may also be a head mounted device, such as a virtual reality headset or glasses or the like. In this scenario, the user may walk around the location or tradeshow with the head mounted device on to find one or more image targets. Generally, the invention includes a software application running on a device 18, which may or may not be in communication with a server 44 via a network 46. Network 46 may be implemented as a single network or a combination of multiple networks. For example, in various embodiments, network 46 may include the Internet and/or one or more intranets, wireless networks (e.g., cellular, wide area network (WAN), WiFi hot spot, WiMax, personal area network (PAN), Bluetooth, etc.), landline networks and/or other appropriate types of communication networks. As such, in various embodiments, computing or mobile device 18 may be associated with a particular link (e.g., a link, such as a URL (Uniform Resource Locator) to an IP (Internet Protocol) address). In one or more embodiments, mobile device 18 may use the remote target database 42 or may transmit the images to a remote server for image target identification.

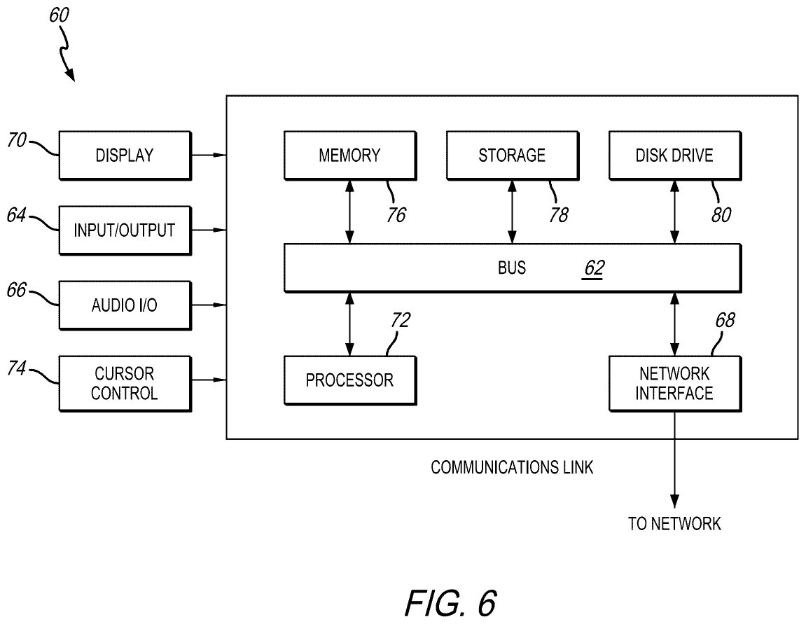

FIG. 6 is a block diagram of a computer system 60 (e.g., mobile device 18 or a head mounted device that includes the computer system built in) suitable for implementing one or more components discussed herein according to one embodiment of the subject matter of the present disclosure. In various implementations, mobile device 18 of the user may comprise a personal computing device (e.g., smart phone, a computing tablet, a personal computer, laptop, PDA, Bluetooth device, key FOB, badge, etc.) capable of communicating with the network. In an embodiment of the invention where the VR/AR assembly is implemented in a single head mounted device or HMD, HMD may comprise a personal computing device incorporated into a pair of glasses or a helmet. HMD may comprise or implement a plurality of hardware components and/or software components that operate to perform various methodologies in accordance with the described embodiments. Exemplary HMD may include, for example, stand-alone and networked computers running mobile OS.

Computer system 60 includes a bus 62 or other communication mechanism for communicating information data, signals, and information between various components of computer system 60. Components include an input/output (I/O) component 64 that processes a user action, such as selecting keys from a virtual keypad/keyboard, selecting one or more buttons or links, etc., and sends a corresponding signal to bus 62. I/O component 64 may also include an output component such as a display medium 70 mounted a short distance in front of the user's eyes, and an input control such as a cursor control 74 (such as a virtual keyboard, virtual keypad, virtual mouse, etc.). An optional audio input/output component 66 may also be included to allow a user to use voice for inputting information by converting audio signals into information signals. Audio I/O component 66 may allow the user to hear audio. A transceiver or network interface 68 transmits and receives signals between computer system 60 and other devices, such as another user device, or another network computing device via a communication link to a network. In one embodiment, the transmission is wireless, although other transmission mediums and methods may also be suitable. A processor 72, which can be a micro-controller, digital signal processor (DSP), or other processing component, processes these various signals, such as for display on computer system 60 or transmission to other devices via communication link. Processor 72 may also control transmission of information, such as cookies or IP addresses, to other devices.

Components of computer system 60 also include a system memory component 76 (e.g., RAM), a static storage component 78 (e.g., ROM), and/or a disk drive 80. Computer system 60 performs specific operations by processor 72 and other components by executing one or more sequences of instructions contained in system memory component 76. Logic may be encoded in a computer readable medium, which may refer to any medium that participates in providing instructions to processor 72 for execution. Such a medium may take many forms, including but not limited to, non-volatile media, volatile media, and transmission media. In various implementations, non-volatile media includes optical, or magnetic disks, or solid-state drives; volatile media includes dynamic memory, such as system memory component 76; and transmission media includes coaxial cables, copper wire, and fiber optics, including wires that comprise bus 62. In one embodiment, the logic is encoded in non-transitory computer readable medium. In one example, transmission media may take the form of acoustic or light waves, such as those generated during radio wave, optical, and infrared data communications.

In various embodiments of the present disclosure, execution of instruction sequences to practice the present disclosure may be performed by computer system 60. In various other embodiments of the present disclosure, a plurality of computer systems 60 coupled by communication link to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, firmware, or combinations thereof. Also where applicable, the various hardware components, software components, and/or firmware components set forth herein may be combined into composite components comprising software, firmware, hardware, and/or all without departing from the spirit of the present disclosure. Where applicable, the various hardware components, software components, and/or firmware components set forth herein may be separated into sub-components comprising software, firmware, hardware, or all without departing from the spirit of the present disclosure. In addition, where applicable, it is contemplated that software components may be implemented as hardware components, and vice-versa. Where applicable, the ordering of various steps described herein may be changed, combined into composite steps, and/or separated into sub-steps to provide features described herein.

Although embodiments of the present disclosure have been described, these embodiments illustrate but do not limit the disclosure. It should also be understood that embodiments of the present disclosure should not be limited to these embodiments but that numerous modifications and variations may be made by one of ordinary skill in the art in accordance with the principles of the present disclosure and be included within the spirit and scope of the present disclosure as hereinafter claimed.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further, any specific numbers noted herein are only examples: alternative implementations may employ differing values, measurements or ranges.

The teachings of the disclosure provided herein can be applied to other systems, not necessarily the system described above. The elements and acts of the various embodiments described above can be combined to provide further embodiments. Any measurements described or used herein are merely exemplary and not a limitation on the present invention. Other measurements can be used. Further, any specific materials noted herein are only examples: alternative implementations may employ differing materials.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A method of obtaining user contact information using an augmented reality system, the method comprising the steps of:
(a) displaying a display member that includes at least a first image target that includes first linked augmented reality content,
(b) prompting a user to utilize a mobile device that includes software running thereon that is associated with the augmented reality system, wherein the software is in communication with a target database, wherein the mobile device includes a camera that has a camera lens, wherein the user orients the mobile device such that the camera lens is directed toward the display member, wherein the first image target is recognized by the software and the first linked augmented reality content is displayed on the mobile device, wherein the user views the first linked augmented reality content on a screen of the mobile device,
(c) prompting the user to submit the user contact information, wherein the user contact information is stored in a user database, and
(d) providing the user with a prize after the user has submitted the user contact information.

2. The method of claim 1 wherein the method is performed at a tradeshow, and wherein the display member is displayed in a booth, wherein the booth includes an exhibitor.

3. The method of claim 2 wherein the first linked augmented reality content is a game that includes a prize indicator that is associated with the prize, wherein prior to step (c), the user plays the game and is informed of the prize indicator.

4. The method of claim 1 wherein the prize is a discount code.

5. The method of claim 2 wherein the mobile device is provided by the exhibitor.

6. The method of claim 2 wherein the mobile device is provided by the user.

7. The method of claim 1 wherein the augmented reality system includes an exhibitor database.

8. A method of obtaining user contact information using an augmented reality system at a tradeshow, the method comprising the steps of:
(a) displaying a display member at a booth of an exhibitor, wherein the display member includes at least a first image target that includes first linked augmented reality content,
(b) prompting a user to utilize a mobile device that includes software running thereon that is associated with the augmented reality system, wherein the software is in communication with a target database, wherein the mobile device includes a camera that has a camera lens, wherein the user orients the mobile device such that the camera lens is directed toward the display member, wherein the first image target is recognized by the software and the first linked augmented reality content is displayed on the mobile device, wherein the user views the first linked augmented reality content on a screen of the mobile device, wherein the first linked augmented reality content is a game that includes a prize indicator, wherein the user plays the game and is informed of the prize indicator,
(c) prompting the user to submit the user contact information, wherein the user contact information is stored in a user database, and
(d) providing the user with a prize that is associated with the prize indicator after the user has submitted the user contact information.

9. The method of claim 8 wherein the mobile device is provided by the exhibitor.

10. The method of claim 8 wherein the mobile device is provided by the user.

11. An augmented reality system comprising:
at least a first display member that includes a first image target, and
software that is configured to run on a mobile device that includes a camera that has a camera lens, wherein the software is in communication with a target database that includes information related to the first image target, wherein the software includes first augmented reality content that is associated with the first image target, wherein the first augmented reality content is a first game configured to provide a first user with a first prize indicator, wherein after the first user submits first user contact information to a user database, a first prize is delivered to the first user via the first user contact information.

12. The augmented reality system of claim 11 wherein the first display member is associated with a first booth and a first exhibitor, wherein the augmented reality system includes a second booth and a second exhibitor, wherein a second display member is associated with the second booth and the second exhibitor, wherein the target database includes information related to the second image target, wherein the software includes second augmented reality content that is associated with the second image target, wherein the second augmented reality content is a second game configured to provide the first user or a second user with a second prize indicator, wherein after the second user submits second user contact information to the user database, a second prize is delivered to the second user via the second user contact information.

13. The augmented reality system of claim 12 further comprising an exhibitor database, wherein first exhibitor information associated with the first exhibitor and second exhibitor information associated with the second exhibitor is included in the exhibitor database, wherein the first user contact information is associated with the first exhibitor and the second user contact information is associated with the second exhibitor.

14. The augmented reality system of claim 11 wherein the augmented reality system is configured to be utilized at a booth of a tradeshow, and wherein the display member is associated with a backdrop of the booth.
